(19) United States
(12) Patent Application Publication
(10) Pub. No.: US 2026/0160908 A1
(43) Pub. Date: Jun. 11, 2026

(54) METHODS AND SYSTEMS FOR MACHINE-LEARNED SEISMIC FAULT DETECTION

(71) Applicant: SAUDI ARABIAN OIL COMPANY, Dhahran (SA)

(72) Inventors: Tong Zhou, Beijing (CN); Yue Ma, Beijing (CN); Yuhan Sui, Beijing (CN); Nasher M. Albinhassan, Dhahran (SA)

(73) Assignee: SAUDI ARABIAN OIL COMPANY, Dhahran (SA)

(21) Appl. No.: 18/707,980

(22) PCT Filed: Jul. 19, 2023
(86) PCT No.: PCT/CN2023/108042

§ 371 Date: May 7, 2024

(51) Int. Cl. G01V 1/30; E21B 41/00; E21B 44/00

(52) U.S. Cl. CPC G01V 1/302; E21B 41/00; E21B 44/00; E21B 2200/22; G01V 2210/642

(57) ABSTRACT

A method for detecting one or more faults in a seismic dataset. The method includes obtaining a seismic data set for a subsurface region of interest and processing the seismic data set with a fault detection system to predict a pixelwise fault probability for the subsurface region of interest. The fault detection system includes a U-net architecture convolutional neural network that includes an encoder branch with N ordered encoder blocks and a decoder branch with N ordered decoder blocks, where the N encoder blocks and N decoder blocks are paired and each pair is connected by a multiscale transformer and channel mixing block. The method further includes determining a location of a hydrocarbon reservoir in the subsurface region of interest using the pixelwise fault probability.

### BACKGROUND

In the context of oil and gas exploration and production, a variety of tools and methods are employed to model subsurface regions and plan wellbore paths to extract desired hydrocarbons. To understand and model a subsurface region of interest, seismic experiments and/or surveys are often conducted. In a seismic survey, energy is emitted from a source, where the source is often on the surface of the Earth, into the subsurface region of interest. The emitted energy propagates as a wavefield through the subsurface region of interest and a portion of the propagating energy is reflected at geological interfaces joining portions of the subsurface with differing lithostratigraphic properties (i.e., regions of different rock types). Eventually, reflected wavefields return to the surface of the Earth and the amplitudes of these wavefields are recorded with respect to time by one or more seismic receivers. The collection of recorded amplitudes in time over one or more seismic receivers may be considered a seismic dataset.

A seismic dataset contains information about subsurface reflectors, or geological interfaces, indicating changes in acoustic properties that usually coincide with changes in lithology in the subsurface region of interest. To determine the structure of the subsurface, including the presence of hydrocarbons, the seismic dataset may be processed. Processing a seismic dataset includes a sequence of steps designed to correct one or more issues, such as near-surface effects, noise, and irregularities in the seismic survey geometry, etc. In another step, in processing a seismic dataset a seismic velocity model may be determined representing the speed at which seismic waves propagate at various points within subsurface. The seismic dataset and the seismic velocity model may be combined using a process called “migration” to form a seismic image of the subsurface. Typically, such a seismic image displays points of high and low seismic reflection amplitude on a color scale or grayscale on a dense two-dimensional (2D) or three-dimensional (3D) grid of points representing the subsurface below the seismic survey area.

Although, the seismic image is influenced by the geological structures within the subsurface it does not directly identify what those structures are. For example, the seismic image may show a continuous band or surface of high amplitude reflection extending across the 3D grid of points and additional step is required to identify or label that band or surface as a geological boundary or interface separating different types of rocks (“geological formations”). This step, of identifying the geological structures that are generating features in the seismic image is called seismic interpretation and is typically conducted using a seismic interpretation workstation. The result of seismic interpretation may be a 2D or 3D model of the geology within the subsurface. Such a model may typically be called a “geological model”.

In many scenarios, an important aspect of the interpretation of seismic data is the detection of seismic faults (or, more simply, faults). In practice, the detection of one or more faults through inspection and analysis of a seismic dataset requires a large amount of human labor and significant computational processing time. This is because discontinuities in a high amplitude reflection surface must be interpreted in the context of the rest of the seismic image before it can confidently be identified or labelled as a geological fault or fracture. Further, generally, fault detection methods are either sensitive to noise, resulting in erroneously identified faults or undetected faults, and/or limited in detecting high dip angle major faults. Accordingly, there exists a need to accurately, consistently, and quickly detect faults through analysis of one or more seismic datasets. The interpreted seismic dataset, with detected seismic faults may be used, among other things, to identify a location of one or more hydrocarbon reservoirs.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method for detecting one or more faults in a seismic dataset. The method includes obtaining a seismic data set for a subsurface region of interest and processing the seismic data set with a fault detection system to predict a pixelwise fault probability for the subsurface region of interest. The fault detection system includes a U-net architecture convolutional neural network that includes an encoder branch with N ordered encoder blocks and a decoder branch with N ordered decoder blocks, where the N encoder blocks and N decoder blocks are paired and each pair is connected by a multiscale transformer and channel mixing block. The method further includes determining a location of a hydrocarbon reservoir in the subsurface region of interest using the pixelwise fault probability.

Embodiments disclosed herein generally relate to a non-transitory computer readable medium storing instructions executable by a computer processor. The instructions include functionality for obtaining a seismic data set for a subsurface region of interest and processing the seismic data set with a fault detection system to predict a pixelwise fault probability for the subsurface region of interest. The fault detection system includes a U-net architecture convolutional neural network that includes an encoder branch with N ordered encoder blocks and a decoder branch with N ordered decoder blocks, where the N encoder blocks and N decoder blocks are paired and each pair is connected by a multiscale transformer and channel mixing block. The instructions further include functionality for determining a location of a hydrocarbon reservoir in the subsurface region of interest using the pixelwise fault probability.

Embodiments disclosed herein generally relate to a system that includes a fault detection system configured to receive a seismic dataset and output a pixelwise fault probability and a computer. The computer is configured to receive the seismic data set for a subsurface region of interest and process the seismic data set with the fault detection system to predict the pixelwise fault probability for the subsurface region of interest. The fault detection system includes a U-net architecture convolutional neural network that includes an encoder branch with N ordered encoder blocks and a decoder branch with N ordered decoder blocks, where the N encoder blocks and N decoder blocks are paired and each pair is connected by a multiscale transformer and channel mixing block. The computer is further configured to determine a location of a hydrocarbon reservoir in the subsurface region of interest using the pixelwise fault probability.

Other aspects and advantages of the claimed subject matter will be apparent from the following description and the appended claims.

### BRIEF DESCRIPTION OF DRAWINGS

FIG. 1 depicts a system in accordance with one or more embodiments.

FIG. 2 depicts a seismic survey in accordance with one or more embodiments.

FIG. 3 depicts an example seismic image in accordance with one or more embodiments.

FIG. 4 depicts a system in accordance with one or more embodiments.

FIG. 5 depicts a neural network in accordance with one or more embodiments.

FIG. 6 depicts a U-net convolutional neural network with multiscale transformer and channel mixing blocks in accordance with one or more embodiments.

FIG. 7 depicts an encoding block in accordance with one or more embodiments.

FIG. 8 depicts a multiscale transformer and channel mixing block in accordance with one or more embodiments.

FIG. 9 depicts a patch partitioner and patch embedder in accordance with one or more embodiments.

FIG. 10 depicts a transformer in accordance with one or more embodiments.

FIG. 11 depicts a channel mixing block in accordance with one or more embodiments.

FIG. 12A depicts a synthetically generated seismic data set in accordance with one or more embodiments.

FIG. 12B depicts a target mask in accordance with one or more embodiments.

FIG. 13 depicts a flowchart in accordance with one or more embodiments.

FIG. 14 demonstrates fault detection system predictions in accordance with one or more embodiments.

FIG. 15 demonstrates fault detection system predictions in accordance with one or more embodiments.

FIG. 16 depicts a flowchart in accordance with one or more embodiments.

FIG. 17 depicts a drilling system in accordance with one or more embodiments.

FIG. 18 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

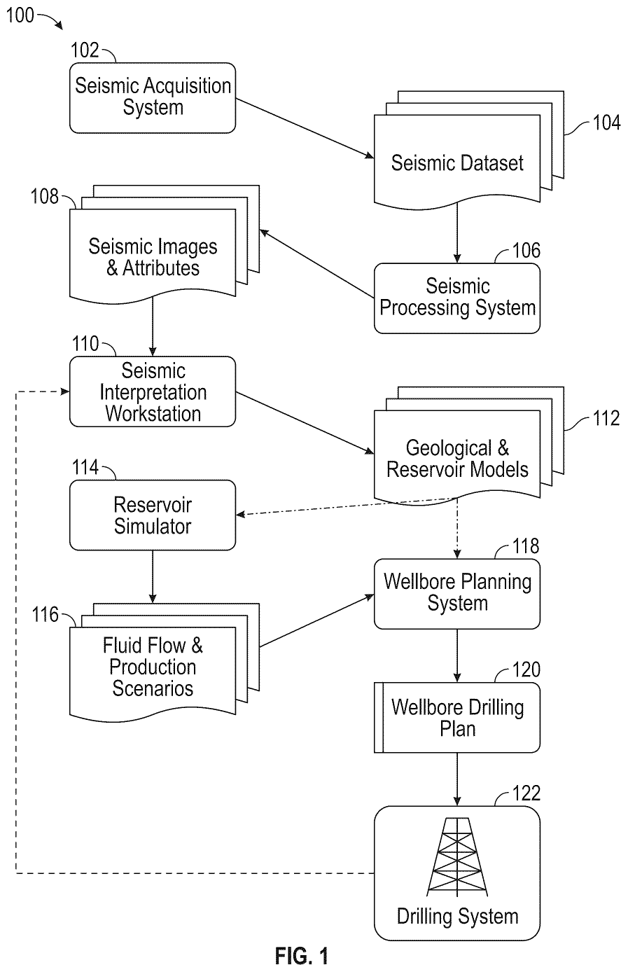

In the following description of FIGS. 1-18, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Interpreting seismic images is an important step in the search for hydrocarbon reservoirs beneath the surface of the earth and in deciding how best to produce oil and gas from the reservoirs. Interpretation includes identifying the geological structures that are causing features visible in the seismic image may include building geological models, i.e., 2D or 3D representations of the subsurface geological structure. Such features may include, without limitation, boundaries between geological (rock) layers, faults and fractures, facies (i.e., rock type categories) and interfaces between pore fluids. In particular, the detection of one or more faults through inspection and analysis of a seismic dataset is costly in terms of both computational resources and human labor. This is because discontinuities in a high amplitude reflection surface must be interpreted contextually with the entire seismic dataset. Further, generally, fault detection methods are either sensitive to noise, resulting in erroneously identified faults or undetected faults, and/or limited in detecting high dip angle major faults. Embodiments disclosed herein relate to machine-learned methods and systems for quick, consistent, and accurate detection of seismic faults in a seismic dataset and/or seismic image.

FIG. 1 depicts a flow diagram (100) in accordance with one or more embodiments. FIG. 1 illustrates the steps of acquiring remote sensing data, processing the remote sensing data, forming a geological model, optionally simulating the flow of fluids, including hydrocarbons, though the geological model, the planning of wellbores including their surface position, trajectories, and targets, and the drilling of those wellbores. Although the steps in flowchart (100) are shown in sequential order, it will be apparent to one of ordinary skill in the art, that some steps may be conducted in parallel, or in a different order than shown, or may be omitted without departing form the scope of the invention.

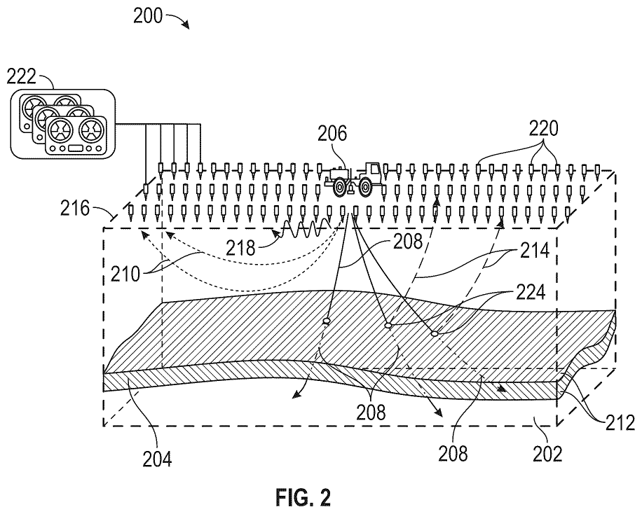

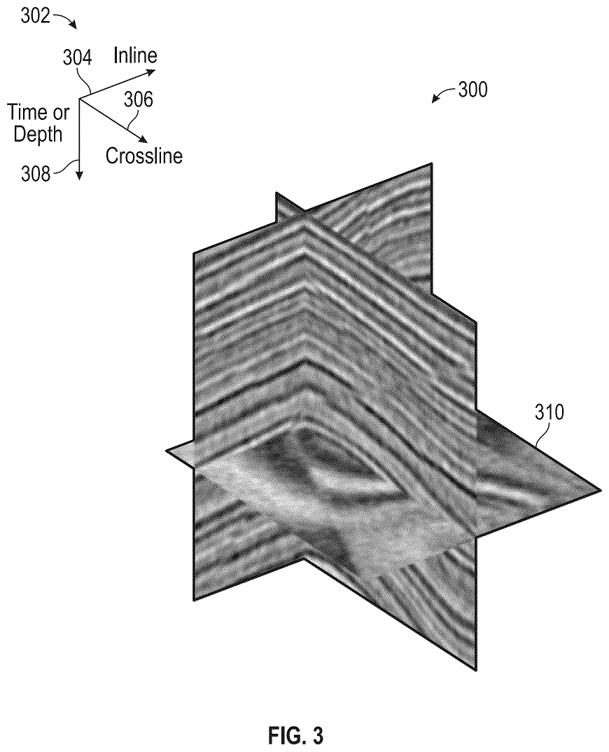

For example, flow diagram (100) may begin with the use of a seismic acquisition system (102) to acquire a seismic dataset (104) over a subterranean region of interest. The seismic acquisition system (102) will be described in more detail in the context of FIG. 2, and an example of a seismic dataset is shown in FIG. 3. Other remote sensing datasets may also be collected at this stage to characterize the subterranean region of interest. For example, resistivity, transient electromagnetic, and/or gravitation surveys may be collected.

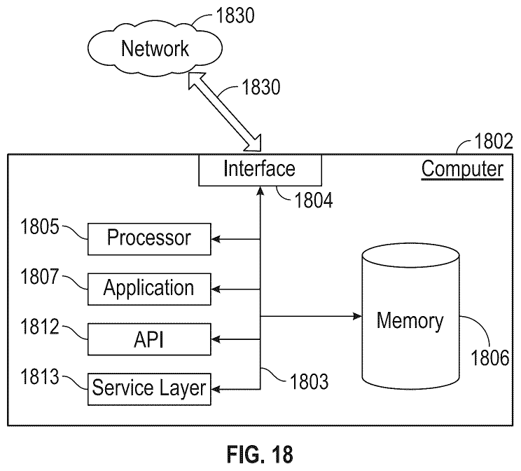

The seismic dataset contains seismic recordings that are influenced by the geological structure of the subterranean region. However, seismic datasets (104) also contain a wide variety of noise and distortion and does not in its unprocessed “raw” form display significant useful information about the subterranean region. Consequently, seismic datasets (104) are typically processed to remove or attenuate noise and to correctly locate geological boundaries that reflect seismic waves (“seismic reflectors” in two-dimensional (“2D”) or three-dimensional (“3D”) space within the subterranean region. It will be appreciated by one of ordinary skill in the art that seismic datasets (104) are extremely large, typically occupying hundreds of Terabytes or more than a Petabyte in size and cannot be manipulated or “processed” without the assistance of a purpose-configured seismic processing system (106). A seismic processing system (106) may be composed of a computer system, such as the computer system shown in FIG. 18 configured with appropriate seismic processing software and augmented with a number of purpose specific elements, such as high capacity tape drives or hard drives connected through high-speed buses to computer processing units (“CPUs”). Further the CPUs of a seismic processing unit will typically be connected to a plurality of graphical processing units (“GPUs”) that perform many of the computational operations on the seismic dataset (104).

The result of processing a seismic dataset (104) with a seismic processing system (106) is a seismic image (108). The seismic image is a 2D or 3D image of the points within the subsurface that generate a distinctive seismic response. For example, the seismic image (108) may display the points at which seismic energy is reflected, or scattered, within the subsurface. Other seismic characteristics or “attributes” of the subsurface may be displayed as a seismic image (108). For example, the strength of conversion of energy from one type of seismic wave to another, or the strength of absorption of seismic energy, or the velocity of seismic propagation may be displayed as a function of subsurface position in the seismic image (108). The examples of seismic attributes given above are purely illustrative, and a person of ordinary skill in the art will appreciate that anyone of dozens of other attributes may be displayed as a seismic image (108) and the examples described should not be interpreted as limiting the scope of the invention in any way.

The seismic image (108) is an image, typically composed of pixels or varying intensity, and is not itself a model of the geological structure of the subterranean region to which it pertains. To determine the geological structure corresponding to, or that produced, the seismic image (108) the seismic image (108) is typically “interpreted” using a seismic interpretation workstation (110). A seismic interpretation workstation (110) is typically composed of a computer system similar to the computer system shown in FIG. 18 and configured with seismic interpretation software and augmented with purpose specific peripherals such as high capability display devices that may include immersive or virtual reality devices, such as virtual-reality headsets or immersive “caves”, and enhanced means of interacting with the seismic image (108) such as a mouse, wand, or gesture-responsive sensors.

Additional data may be used within the seismic interpretation workstation (110) to facilitate the interpretation of the seismic dataset (104). Such additional data may include well logs acquired from previously drilled wells and acquired either while-drilling or via wireline conveyed well logging tools after drilling. Such data may also include non-seismic remote sensing datasets such as resistivity, transient electromagnetic, and/or gravitational surveys.

The result of interpreting the seismic image may be a geological model (112) of the subsurface, including reservoir models (112) of hydrocarbon reservoirs within the subterranean region of interest. Geological models (112) may include the locations of geological interfaces, such as the boundary between volumes (“formations”) containing different rock types (“facies”), and faults and fractures. Geological models (112) may also include descriptions of the characteristics of the different facies including characteristics such as porosity and permeability, and the relative amounts of different fluids, such as gas, oil and brine, within the pores in each facies.

In some embodiments, the geological models (112) may be used directly to create a wellbore drilling plan (120) using a wellbore planning system (118). Such a wellbore drilling plan (120) may contain drilling targets: geological regions expected to contain hydrocarbons. The wellbore planning system (118) may plan wellbore trajectories to reach the drilling targets while simultaneously avoiding drilling hazard, such as preexisting wellbores, shallow gas pockets, and fault zones, and not exceeding the constraints, such as torque, drag and wellbore curvature, of the drilling system. Similarly, the wellbore drilling plan (120) may include a determination of wellbore caliper, and casing points.

The wellbore planning system (118) may include dedicated software stored on a memory of a computer system, such as the computer system shown in FIG. 18. The wellbore plan (120) may be informed by the best available information at the time of planning. This may include models encapsulating subterranean stress conditions, the trajectory of any existing wellbores (which may be desirable to avoid), and the existence of other drilling hazards, such as shallow gas pockets, over-pressure zones, and active fault planes.

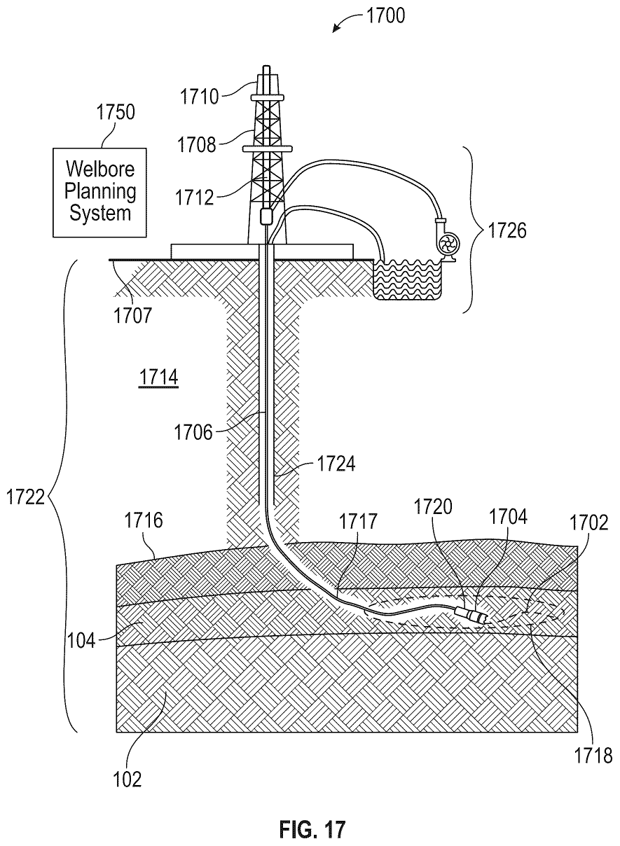

FIG. 17 depicts a drilling system (1700) used to drill a wellbore (1717) along a wellbore path (1702). The drilling system (1700) of FIG. 17 will be discussed in greater detail later in the disclosure. For now, it may be said that the wellbore path (1702) can include a starting surface location of the wellbore, or a subsurface location within an existing wellbore, from which the wellbore (1717) may be drilled. The wellbore path (1702) may further include a terminal location that may intersect with the previously located hydrocarbon reservoir (204). The wellbore path (1702) may further still include wellbore geometry information such as wellbore diameter and inclination angle and when each of these change along the depth of the wellbore. If casing is used, the wellbore plan (120) may include casing type or casing depths. Furthermore, the wellbore plan (120) may consider other engineering constraints such as the maximum wellbore curvature (“dog-log”) that a drillstring of a drilling system may tolerate and the maximum torque and drag values that the drilling system may tolerate. The wellbore plan (120) may further define associated drilling parameters, such as the planned depths at which casing will be inserted to support the wellbore (1717) to prevent formation fluids entering the wellbore (1717) and the drilling mud weights (densities) and types that may be used during drilling of the wellbore (1717).

In other embodiments, the geological model (112) may be input to a reservoir simulator (114). A reservoir simulator (114) comprises functionality for simulating the flow of fluids, including hydrocarbon fluids such as oil and gas, through a hydrocarbon reservoir composed of porous, permeable reservoir rocks in response to natural and anthropogenic pressure gradients. The reservoir simulator (114) may be used to predict changes in fluid flow, including fluid flow into well penetrating the reservoir as a result of planned well drilling, and fluid injection and extraction. For example, the reservoir simulator may be used to predict fluid-flow and production scenarios (116) including changes in hydrocarbon production rate that would result from the injection of water into the reservoir from wells around the reservoirs periphery.

The reservoir simulator (114) may use a geological model or reservoir model (112) that contains a digital description of the physical properties of the rocks as a function of position within the reservoir and the fluids within the pores of the porous, permeable reservoir rocks at a given time. In some embodiments, the digital description may be in the form of a dense 3D grid with the physical properties of the rocks and fluids defined at each node. In some embodiments, the 3D grid may be a cartesian grid, while in other embodiments the grid may be an irregular grid.

The physical properties of the rocks and fluids within the reservoir may be obtained from a variety of geological and geophysical sources. For example, remote sensing geophysical surveys, such as seismic surveys, gravity surveys, and active and passive source resistivity surveys, may be employed. In addition, data collected from well logs acquired in well penetrating the reservoir may be used to determine physical and petrophysical properties along the segment of the well trajectory traversing the reservoir. For example, porosity, permeability, density, seismic velocity, and resistivity may be measured along these segments of wellbore. In accordance with some embodiments, remote sensing geophysical surveys and physical and petrophysical properties determined from well logs may be combined to estimate physical and petrophysical properties for the entire reservoir simulation model grid.

Reservoir simulators solve a set of mathematical governing equations that represent the physical laws that govern fluid flow in porous, permeable media. For example, the flow of a single-phase slightly compressible oil with a constant viscosity and compressibility the equations capture Darcy's law, the continuity condition and the equation of state.

Additional, and more complicated equations are required when more than one fluid, or more than one phase, e.g., liquid and gas, are present in the reservoir. Further, when the physical and petrophysical properties of the rocks and fluids vary as a function of position the governing equations may not be solved analytically and must instead be discretized into a grid of cells or blocks. The governing equations must then be solved by one of a variety of numerical methods, such as, without limitation, explicit or implicit finite-difference methods, explicit or implicit finite element methods, or discrete Galerkin methods.

The fluid flow and production scenarios (116) produced by the reservoir simulator (114) may then be used by the wellbore planning system (118) to determine the wellbore drilling plan (120).

FIG. 2 shows a seismic acquisition system (200) configured for acquiring a seismic dataset pertaining to a subterranean region of interest (202). The subterranean region of interest (202) may or may not contain a hydrocarbon reservoir (204). The purpose of the seismic survey may be to determine whether or not a hydrocarbon reservoir (204) is present within the subterranean region of interest (202).

The seismic acquisition system (200) may utilize a seismic source (206) positioned on the surface of the earth (216). On land the seismic source (206) is typically a vibroseis truck (as shown) or, less commonly, explosive charges, such as dynamite, buried to a shallow depth. In water, particularly in the ocean, the seismic source may commonly be an airgun (not shown) that releases a pulse of high-pressure gas when activated. Whatever its mechanical design, the seismic source (206), when activated, generates radiated seismic waves, such as those whose paths are indicated by the rays (208). The radiated seismic waves may be bent (“refracted”) by variations in the speed of seismic wave propagation within the subterranean region (202) and return to the surface of the earth (216) as refracted seismic waves (210). Alternatively, radiated seismic waves may be partially or wholly reflected by seismic reflectors, at reflection points such as (224), and return to the surface as reflected seismic waves (214). Seismic reflectors may be indicative of the geological boundaries (212), such as the boundaries between geological layers, the boundaries between different pore fluids, faults, fractures or groups of fractures within the rock, or other structures of interest in the seismic for hydrocarbon reservoirs.

At the surface, the refracted seismic waves (210) and reflected seismic waves (214) may be detected by seismic receivers (220). On land a seismic receiver (220) may be a geophone (that records the velocity of ground motion) or an accelerometer (that records the acceleration of ground motion). In water, the seismic receiver may commonly be a hydrophone that records pressure disturbances within the water. Irrespective of its mechanical design or the quantity detected, seismic receivers (220) convert the detected seismic waves into electrical signals, that may subsequently be digitized and recorded by a seismic recorder (222) as a time-series of samples. Such a time-series is typically referred to as a seismic “trace” and represents the amplitude of the detected seismic wave at a plurality of sample times. Usually, the sample times are referenced to the time of source activation and the sample times are referred to as “recording times”. Thus, zero recording time occurs at the moment the seismic source is activated.

Each seismic receivers (220) may be positioned at a seismic receiver location that may be denoted (xᵣ, yᵣ) where x and y represent orthogonal axes, such as North-South and East-West, on the surface of the earth (216) above the subterranean region of interest (202). Thus, the refracted seismic waves (210) and reflected seismic waves (214) generated by a single activation of the seismic source (206) may be represented as a three-dimensional “3D” volume of data with axes (xᵣ, yᵣ, t) where t indicates the recording time of the sample, i.e., the time after the activation of the seismic source (206).

Typically, a seismic survey includes recordings of seismic waves generated by one or more seismic sources (206) positioned at a plurality of seismic source locations denoted (xₛ, yₛ). In some case, a single seismic source (206) may be used to acquire the seismic survey, with the seismic source (206) being moved sequentially from one seismic source location to another. In other cases, a plurality of seismic sources, such as seismic source (206) may be used, each occupying and being activated (“fired”) sequential at a subset of the total number of seismic source locations used for the survey. Similarly, some or all of the seismic receivers (220) may be moved between firing of the seismic source (206). For example, seismic receivers (220) may be moved such that the seismic source (206) remains at the center of the area covered by the seismic receivers (220) even as the seismic source (206) is moved from one seismic source location to the next. In other case, such as marine seismic acquisition (not shown) the seismic source may be towed a short distance behind a seismic vessel and strings of receivers attached to multiple cables (“streamers”) are towed behind the seismic sources. Thus, a seismic dataset, the aggregate of all the seismic data acquired by the seismic survey, may be represented as a five-dimensional volume, with coordinate axes (xᵣ, yᵣ, yₛ, yₛ, t).

To determine earth structure, including the presence of hydrocarbons, the seismic data set may be processed. Processing a seismic dataset includes a sequence of steps designed to correct for near-surface effects, attenuate noise, compensate for irregularities in the seismic survey geometry, calculate a seismic velocity model, image reflectors in the subterranean and calculate a plurality of seismic attributes to characterize the subterranean region of interest to determine a drilling target. Critical steps in processing seismic data include a seismic migration. Seismic migration is a process by which seismic events are re-located in either space or time to their true subsurface positions.

Seismic noise may be any unwanted recorded energy that is present in a seismic data set. Seismic noise may be random or coherent and its removal, or “denoising,” is desirable in order to improve the accuracy and resolution of the seismic image. For example, seismic noise may include, without limitation, swell, wind, traffic, seismic interference, mud roll, ground roll, and multiples. A properly processed seismic data set may aid in decisions as to if and where to drill for hydrocarbons. Processing a seismic dataset to form a seismic image may include, but is not limited to: applying quality control methods to identify and correct for anomalous data (e.g., from a faulty seismic receiver (220)); application of a bandpass filter to remove low signal-to-noise (SNR) frequency bands; and normal moveout (NMO) correction.

FIG. 3 shows an illustrative example of a seismic image (300), or an at least partially processed seismic dataset. In the example of FIG. 3, the seismic image is three-dimensional and, for visualization purposes, only select planes of the three-dimensional image are displayed. The seismic image (300) is oriented according to a coordinate system (302) with an inline axis (304), crossline axis (306), and time or depth axis (308). The seismic image (300) is shown in grayscale where color correlates with the amplitude of each recorded sample. Reflections appear as quasi-continuous (“coherent”) curves traversing the seismic image (300).

Hereto, the term seismic image has been used to refer to a seismic dataset that has undergone at least some preprocessing or processing steps (e.g., denoising). In general, the seismic fault detection system described herein may be applied to “raw” seismic data (i.e., seismic data sets) or seismic data sets that have undergone some form of preprocessing or processing (i.e., seismic images). In one or more embodiments, application of the seismic fault detection system to a seismic data set or a seismic image may be considered a processing step. To remove ambiguity, only the term seismic dataset will be used hereafter. It will be well understood by someone with ordinary skill in the art that the seismic fault detection system described herein can operate on seismic datasets that have undergone some form of preprocessing and/or processing. Further, in general, a seismic dataset is not limited to a single dimensionality (e.g., 2D slice). A seismic data set may be 1D vector, a 2D slice, a 3D volume, or other higher-dimensional structures if considered appropriate based on the configuration of the seismic acquisition system (102). Examples herein will use 3D volumes, such as the seismic image (300) displayed in FIG. 3, however, embodiments disclosed herein are not limited to solely three-dimensional seismic data sets.

Embodiments disclosed herein relate to fault detection system that may accurately, consistently, and quickly detect faults in a seismic data set. In one or more embodiments, the fault detection system is based on a machine-learned model with a “U-net” style convolutional neural network (CNN) with multiscale transformer and channel mixing blocks used in place of conventional skip connections. More information regarding machine learning and a CNN with multiscale transformer and channel mixing blocks will be presented later in the instant disclosure. Detection of faults in a seismic data set may be considered a type of seismic interpretation, or a seismic interpretation process. As such, in one or more embodiments, the fault detection system may be implemented using, or on, a seismic interpretation workstation (110) and the resulting detected faults may be used to construct geological and reservoir models (112) and ultimately inform the planning and drilling of a wellbore.

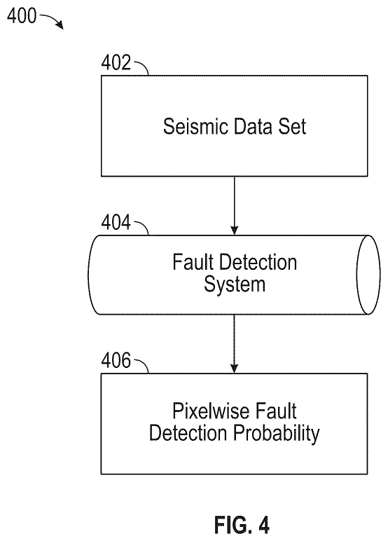

FIG. 4 depicts a high-level overview (400) of the fault detection process, in accordance with one or more embodiments. First, a seismic data set (402) is collected. The seismic data set (402) may be acquired from a seismic survey (200). Further, the seismic data set (402) may undergo any pre-processing (or processing) steps known in the art. The seismic data set (402), regardless of its dimensionality (2D, 3D, etc.) will be said to be composed of pixels, or data elements. The seismic data set (402) is processed with the fault detection system (404), in accordance with one or more embodiments. The fault detection system uses a machine-learned model. The machine-learned model and the data used to train it will be described in greater detail later in the instant disclosure. However, for now, it is stated that the fault detection system (404) is configured to receive the seismic data set (402) and, upon processing, output a pixelwise fault detection probability (406). The pixelwise fault detection probability is a data structure of the same dimensionality and size as the seismic data set (402) (i.e., composed of the same number of pixels) and the value of each pixel represents the probability that a fault exists at that pixel.

Machine learning (ML), broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein. However, one skilled in the art will recognize that the concepts and methods detailed hereafter are not limited by this choice of nomenclature.

Machine-learned model types may include, but are not limited to, generalized linear models, Bayesian regression, random forests, and deep models such as neural networks, convolutional neural networks, and recurrent neural networks. Machine-learned model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. It is noted that in the context of machine learning (ML), the regularization of a machine-learned model refers to a penalty applied to the loss function of the machine-learned model and should not be confused with the regularization of a seismic data set (a possible pre-processing step). Commonly, in the literature, the selection of hyperparameters surrounding a machine-learned model is referred to as selecting the model “architecture”. Once a machine-learned model type and hyperparameters have been selected, the machine-learned model is trained to perform a task. In accordance with one or more embodiments, a machine-learned model type and associated architecture are selected, the machine-learned model is trained to determine a pixelwise fault detection probability given an input seismic data set, the performance of the machine-learned model is evaluated, and the machine-learned model is used in a production setting (also known as deployment of the machine-learned model).

As noted, the objective of the machine-learned model disclosed herein is to determine a pixelwise fault detection probability (406) given a seismic data set (402). In accordance with one or more embodiments, the selected machine-learned model (404) type is a convolutional neural network (CNN) with multiscale transformer and channel mixing blocks connecting pairs of encoder and decoder blocks. A CNN may be more readily understood as a specialized neural network (NN). Thus, a cursory introduction to a NN and a CNN are provided herein. However, it is noted that many variations of a NN and CNN exist. Therefore, one with ordinary skill in the art will recognize that any variation of the NN or CNN (or any other machine-learned model) may be employed without departing from the scope of this disclosure. Further, it is emphasized that the following discussions of a NN and a CNN are basic summaries and should not be considered limiting.

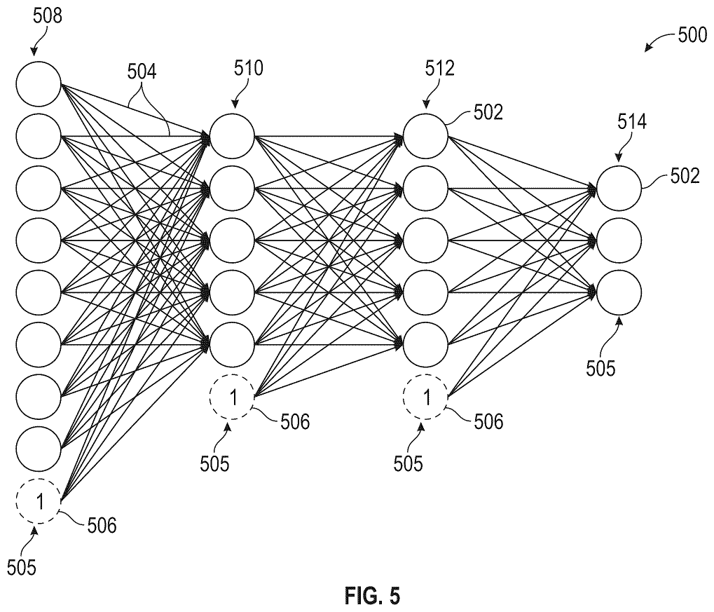

A diagram of a neural network is shown in FIG. 5. At a high level, a neural network (500) may be graphically depicted as being composed of nodes (502), where here any circle represents a node, and edges (504), shown here as directed lines. The nodes (502) may be grouped to form layers (505). FIG. 5 displays four layers (508, 510, 512, 514) of nodes (502) where the nodes (502) are grouped into columns, however, the grouping need not be as shown in FIG. 5. The edges (504) connect the nodes (502). Edges (504) may connect, or not connect, to any node(s) (502) regardless of which layer (505) the node(s) (502) is in. That is, the nodes (502) may be sparsely and residually connected. A neural network (500) will have at least two layers (505), where the first layer (508) is considered the “input layer” and the last layer (514) is the “output layer”. Any intermediate layer (510, 512) is usually described as a “hidden layer”. A neural network (500) may have zero or more hidden layers (510, 512) and a neural network (500) with at least one hidden layer (510, 512) may be described as a “deep” neural network or as a “deep learning method”. In general, a neural network (500) may have more than one node (502) in the output layer (514). In this case the neural network (500) may be referred to as a “multi-target” or “multi-output” network.

Nodes (502) and edges (504) carry additional associations. Namely, every edge is associated with a numerical value. The edge numerical values, or even the edges (504) themselves, are often referred to as “weights” or “parameters”. While training a neural network (500), numerical values are assigned to each edge (504). Additionally, every node (502) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ 1$$

where i is an index that spans the set of “incoming” nodes (502) and edges (504) and ƒ is a user-defined function. Incoming nodes (502) are those that, when viewed as a graph (as in FIG. 5), have directed arrows that point to the node (502) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0, x), however, many additional functions are commonly employed. Every node (502) in a neural network (500) may have a different associated activation function. Often, as a shorthand, activation functions are described by the function ƒ by which it is composed. That is, an activation function composed of a linear function ƒ may simply be referred to as a linear activation function without undue ambiguity.

When the neural network (500) receives an input, the input is propagated through the network according to the activation functions and incoming node (502) values and edge (504) values to compute a value for each node (502). That is, the numerical value for each node (502) may change for each received input. Occasionally, nodes (502) are assigned fixed numerical values, such as the value of 1, that are not affected by the input or altered according to edge (504) values and activation functions. Fixed nodes (502) are often referred to as “biases” or “bias nodes” (506), displayed in FIG. 5 with a dashed circle.

In some implementations, the neural network (500) may contain specialized layers (505), such as a normalization layer, or additional connection procedures, like concatenation. One skilled in the art will appreciate that these alterations do not exceed the scope of this disclosure.

As noted, the training procedure for the neural network (500) comprises assigning values to the edges (504). To begin training the edges (504) are assigned initial values. These values may be assigned randomly, assigned according to a prescribed distribution, assigned manually, or by some other assignment mechanism. Once edge (504) values have been initialized, the neural network (500) may act as a function, such that it may receive inputs and produce an output. As such, at least one input is propagated through the neural network (500) to produce an output. Training data is provided to the neural network (500). Generally, training data consists of pairs of inputs and associated targets. The targets represent the “ground truth”, or the otherwise desired output, upon processing the inputs. In the context of the instant disclosure, an input is a seismic data set and its associated target is a mask of labelled pixels indicating if each pixel represents a fault or not. During training, the neural network (500) processes at least one input from the training data and produces at least one output. Each neural network (500) output is compared to its associated input data target. The comparison of the neural network (500) output to the target is typically performed by a so-called “loss function”; although other names for this comparison function such as “error function”, “misfit function”, and “cost function” are commonly employed. Many types of loss functions are available, such as the mean-squared-error function, however, the general characteristic of a loss function is that the loss function provides a numerical evaluation of the similarity between the neural network (500) output and the associated target. The loss function may also be constructed to impose additional constraints on the values assumed by the edges (504), for example, by adding a penalty term, which may be physics-based, or a regularization term (not be confused with regularization of seismic data). Generally, the goal of a training procedure is to alter the edge (504) values to promote similarity between the neural network (500) output and associated target over the training data. Thus, the loss function is used to guide changes made to the edge (504) values, typically through a process called “backpropagation”.

While a full review of the backpropagation process exceeds the scope of this disclosure, a brief summary is provided. Backpropagation consists of computing the gradient of the loss function over the edge (504) values. The gradient indicates the direction of change in the edge (504) values that results in the greatest change to the loss function. Because the gradient is local to the current edge (504) values, the edge (504) values are typically updated by a “step” in the direction indicated by the gradient. The step size is often referred to as the “learning rate” and need not remain fixed during the training process. Additionally, the step size and direction may be informed by previously seen edge (504) values or previously computed gradients. Such methods for determining the step direction are usually referred to as “momentum” based methods.

Once the edge (504) values have been updated, or altered from their initial values, through a backpropagation step, the neural network (500) will likely produce different outputs. Thus, the procedure of propagating at least one input through the neural network (500), comparing the neural network (500) output with the associated target with a loss function, computing the gradient of the loss function with respect to the edge (504) values, and updating the edge (504) values with a step guided by the gradient, is repeated until a termination criterion is reached. Common termination criteria are: reaching a fixed number of edge (504) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (504) values are no longer intended to be altered, the neural network (500) is said to be “trained.”

A CNN is similar to a neural network (500) in that it can technically be graphically represented by a series of edges (504) and nodes (502) grouped to form layers. However, it is more informative to view a CNN as structural groupings of weights; where here the term structural indicates that the weights within a group have a relationship. CNNs are widely applied when the data inputs also have a structural relationship, for example, a spatial relationship where one input is always considered “to the left” of another input. Seismic data sets have such a structural relationship because each data element, or pixel, in the seismic data set has a spatial-temporal location. Consequently, a CNN is an intuitive choice for processing a seismic data set.

A structural grouping, or group, of weights is herein referred to as a “filter”. The number of weights in a filter is typically much less than the number of inputs, where here the number of inputs refers to the number of pixels in an image or the number of trace-time (or trace-depth) values in a seismic dataset. In a CNN, the filters can be thought as “sliding” over, or convolving with, the inputs to form an intermediate output or intermediate representation of the inputs which still possesses a structural relationship. Like unto the neural network (500), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening”. The flattened representation may be passed to a neural network (500) to produce a final output. Note, that in this context, the neural network (500) is still considered part of the CNN. Like unto a neural network (500), a CNN is trained, after initialization of the filter weights, and the edge (504) values of the internal neural network (500), if present, with the backpropagation process in accordance with a loss function.

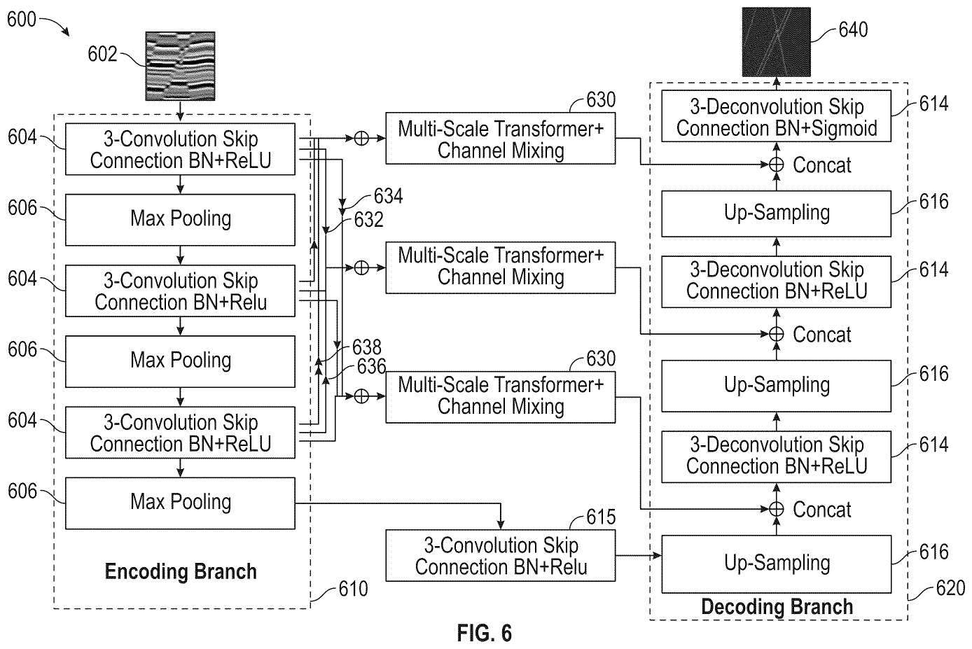

In accordance with one or more embodiments, the architecture of the machine-learned model used in the fault detection system (404) is depicted in FIG. 6. As will be described, the fault detection system (404) depicted in FIG. 6 is a “U-net style” convolutional neural network (CNN) (600). The term U-net is derived because the CNN (600) is composed of an encoder branch (610) and a decoder branch (620) connected by an intermediate connection block (615) that, when illustrated as shown in FIG. 6, form the shape of the letter “U.”

The CNN (600) accepts a seismic data set (402) as an input. In FIG. 6, a 2D example input (602) is depicted. However, as previously discussed, the fault detection system described herein, and therefore the CNN (600), is not limited to two-dimensional seismic data sets. The CNN (600) processes a given seismic dataset with an encoder branch (610). The encoder branch (610) is composed of N encoder blocks (604), where N≥1. The value of N may be considered a hyperparameter that can be prescribed by a user or learned (or tuned) turning a training and validation procedure.

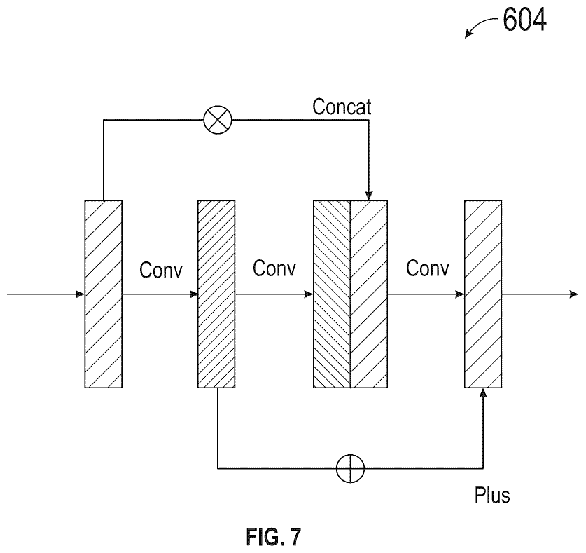

In accordance with one or more embodiments, each encoder block (604) consists of three convolutional operations with skip connections between the first and the third convolution, a batch normalization block followed by the application of an activation function, such as the ReLU activation function. A graphical representation of each encoder block (604) is depicted in FIG. 7. In one or more embodiments, each of the N encoder blocks (604) is followed by a max pooling operation (606). In one or more embodiments, each max pooling operation (606) operates with a kernel size of 2 along each dimension of the original input seismic data set (i.e., 2×2 for 2D, 2×2×2 for 3D, etc.). The max pooling operation (606) is applied to down-sample the data and to enlarge the perceptive field of the next (lower) encoder block (604) in the encoder branch (610), allowing the next encoder block (604) to focus on larger scale features.

An intermediate connection block (615) connects the encoder branch (610) to the decoder branch (620). In one or more embodiments, and as depicted in FIG. 6, the intermediate connection block (615) is composed of three convolutional operations with skip connections between the first and the third convolution and a batch normalization block followed by the application of an activation function similar to the encoder block (604).

The decoding branch (620) is composed of N decoder blocks (614) where each decoder block (614) is paired with an encoder block (604) from the encoder branch (610). In one or more embodiments, each decoder block (614) consists of three deconvolutional operations with skip connections between the first and the third convolution, a batch normalization block followed by the application of an activation function, such as the ReLU activation function. In one or more embodiments, each of the N decoder blocks (614) is preceded by an upsampling operation (616) and a concatenation operation depicted by the symbol ⊕ in FIG. 6. Generally, each upsampling operation (616) operates with a kernel size of the same sized used in an analogous max pooling operation (606). Thus, the upsampling operation (616) serves to reconstruct the intermediate data to the same size and shape as the original input. The concatenation joins data at various stages in the decoding branch (620) with data from various stages of the encoding branch (610). In accordance with one or more embodiments, multiscale transformer and channel mixing blocks (630) are applied to pass the combined multi-scale contextual information from different levels of the encoding branch (610) to the decoding branch (620). Notably, there are N multiscale transformer and channel mixing blocks (630), one for each pair of the encoding blocks (604) and decoding blocks (614). Further, in one or more embodiments and as depicted in FIG. 6, each multiscale transformer and channel mixing block (630) operates on the concatenated output of each encoding block (604) in the encoding branch (610). Because the encoding branch (610) employs max pooling operations (606) (and because depending on the configuration of a convolutional operator, downsampling may occur), the intermediate data outputs from each encoding block (604), when two or more encoding blocks (604) are used, will not be the same size. Consequently, outputs from encoding blocks (604) may need to be upsampled or downsampled in order to ensure their outputs may be concatenated. FIG. 6 depicts directed lines demonstrating how copies of the intermediate data outputs from each encoding block (604) are passed to the multiscale transformer and channel mixing blocks (630). In instances where downsampling or upsampling of the intermediate data must occur to provide congruent data structures, the directed lines of FIG. 6 contain a “mid-line arrowhead.” A single mid-line arrowhead pointing downwards indicates that a single downsampling operation is applied to the intermediate data output before concatenation and subsequent processing with the multiscale transformer and channel mixing block (630). An example single downwards mid-line arrowhead is given the label 632. A double mid-line arrowhead pointing downwards indicates that two downsampling operations are applied to the intermediate data output before concatenation and subsequent processing with the multiscale transformer and channel mixing block (630). An example double downwards mid-line arrowhead is given the label 634. A single mid-line arrowhead pointing upwards indicates that a single upsampling operation is applied to the intermediate data output before concatenation and subsequent processing with the multiscale transformer and channel mixing block (630). An example single upwards mid-line arrowhead is given the label 636. A double mid-line arrowhead pointing upwards indicates that two upsampling operations are applied to the intermediate data output before concatenation and subsequent processing with the multiscale transformer and channel mixing block (630). An example double upwards mid-line arrowhead is given the label 638.

The output of the CNN (600) is a pixelwise fault detection probability (406). An example pixelwise fault detection probability (640) corresponding to the example input (602) is depicted in FIG. 6. The pixelwise fault detection probability is a data structure of the same dimensionality and size as the seismic data set input to the CNN (600) (i.e., composed of the same number of pixels) and the value of each pixel represents the probability that a fault exists at that pixel.

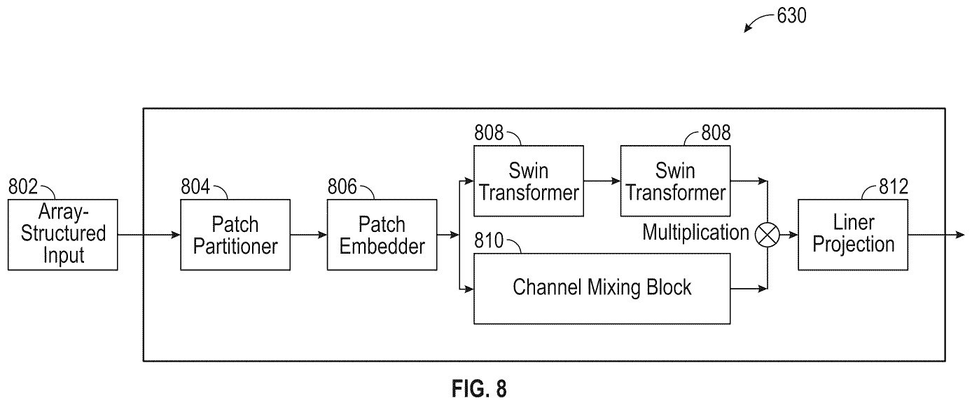

In accordance with one or more embodiments, an important component of the CNN (600) of the fault detection system (404) described herein, is the use of N multiscale transformer and channel mixing blocks (630). As seen in FIG. 6, the multiscale transformer and channel mixing blocks (630) link intermediate data representation at multiple scales from the encoding branch (610) and passes an output to the decoding branch (620). Compared with traditional skip connections, that simply pass copies of intermediate data representations between pairs of encoding blocks (604) and decoding blocks (614), the multiscale transformer and channel mixing blocks (630) can simultaneously model multiscale features with different resolution adding to the expressivity of the CNN (600) and the fault detection system (404). An overview of a multiscale transformer and channel mixing block (630) is depicted in FIG. 8.

To promote generalization and avoid ambiguity among terms, the input received by a multiscale transformer and channel mixing block (630) will be referred to as an array-structured input (802). In general, an array-structured input (802) may have one or more dimensions and one or more elements may exist along each dimension. As seen in FIG. 8, a multiscale transformer and channel mixing block (630) first processes an array-structured input (802) with a patch partitioner (804) and a patch embedder (806). As will be shown, the result of the patch embedder (806) is one or more token vectors. The token vectors are duplicated and one copy is passed through two Swin transformer blocks (808) and the other copy is processed by a channel mixing block (810). The result of the second Swin transformer (808) and the result of the channel mixing block (810) are multiplied together and a linear projection operation (812) is applied to the resultant product. In one or more embodiments, the linear projection operation (812) consists of a single fully connected layer followed by an activation function. In one or more embodiments, the activation function used in the linear projection is the sigmoid function.

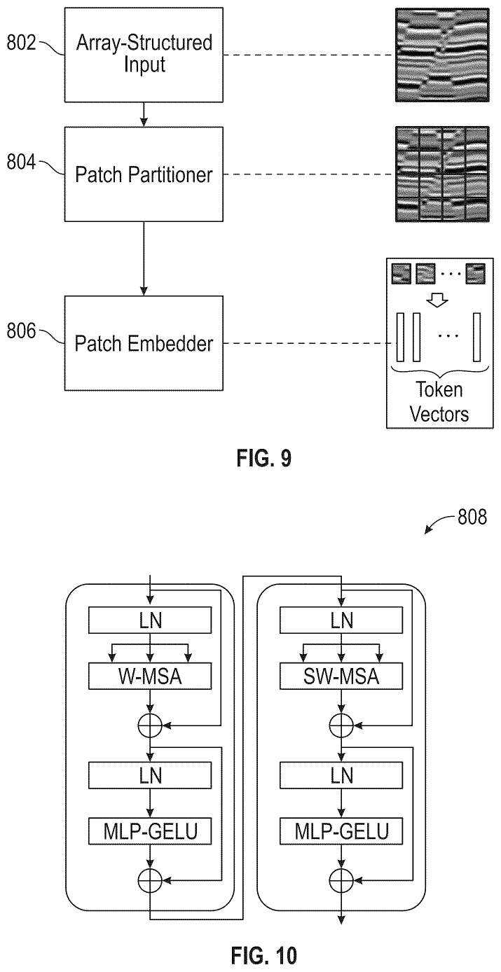

The patch partitioner (804) partitions the array-structured input into one or more patches. The size of each patch, specified by the number of pixels, or elements, along each dimension may be considered a hyperparameter that can be specified by a user or learned during a training process. In one or more embodiments, the size of each patch is 4 pixels along each dimension. Each of the one or more patches is processed by the patch embedder (806) to form a token vector for each patch. In one or more embodiments, the patch embedder (806) simply “flattens,” or converters to a one-dimensional array, each patch. A graphical depiction of the patch partitioner (804) and patch embedder (806) applied to an example 2D array structure is presented in FIG. 9.

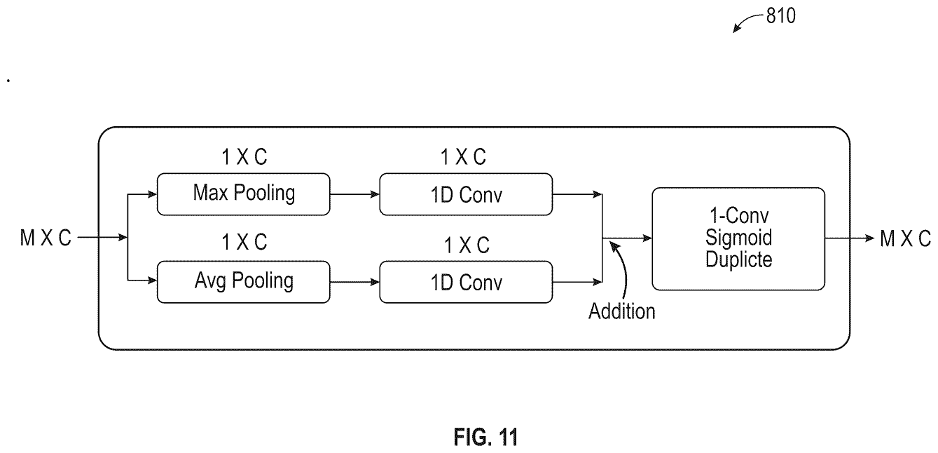

In accordance with one or more embodiments, a Swin transformer (808) consists of sequential layer normalization (LN), windowed multi-head self-attention (W-MSA) or shifted windowed self-attention (SW-MSA), layer normalization, and multi-layer perception (MLP) as depicted in FIG. 10. In one or more embodiments, and as depicted in FIG. 10, each MLP is composed of two fully connected linear layers with a GELU activation function. Further, in one or more embodiments and as depicted in FIG. 10, skip connections are applied inside the Swin transformer (808) to pass residual contextual information. In one or more embodiments, the multi-head self-attention is computed in each window in parallel where the self-attention mechanism is given as

$$Attention ( Q , K , V ) = softmax ( \frac{Q \cdot {K}^{T}}{\sqrt{{d}_{k}}} ) \cdot V , \qquad EQ 2$$

where Q, K, and V are query, key, and value matrixes computed by three linear projections of the token matrix. The linear projection layers are fully connected layers with different weights. dₖ is the number of features (elements) which is used for normalization. Equation (EQ) 2 computes the coherence of each feature between different embedded token vectors, therefore it can measure global coherence between token vectors. This feature helps to overcome the limitations of conventional CNNs which are said to only focus on local features. Finally, a fully connected linear projection layer and Sigmoid activation function outputs a mask showing the fault probabilities, which has the same dimension as the input seismic image at each level.

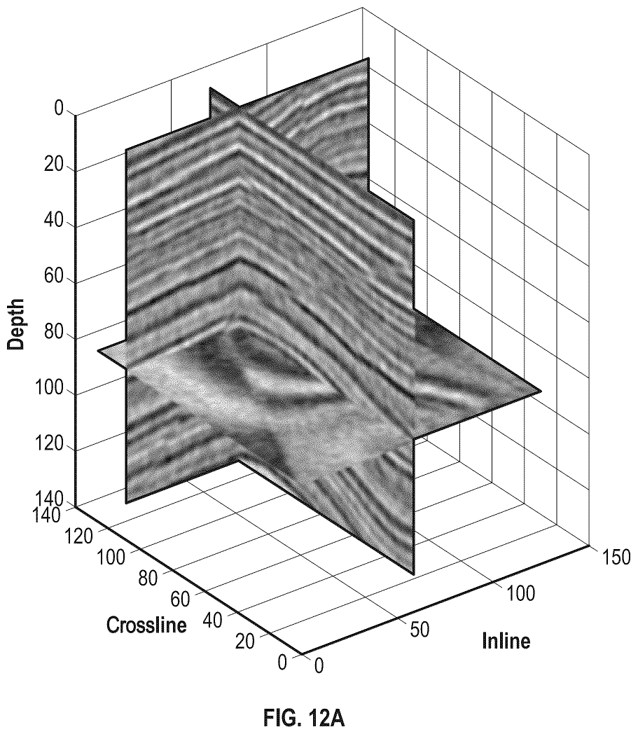

In accordance with one or more embodiments, the channel mixing block (810) is depicted in FIG. 11. A seen, the channel mixing block (810) duplicates a received input of size M×C. In one or more embodiments, C is the number of channels and M is the number of pixels in a patch. One copy is processed with a max pooling operation and the other copy with an average pooling operation. These copies are then each processed by a 1D convolution operation to implement the channel mixing. Subsequently, in one or more embodiments, the copies are added together and processed by another 1D convolution operation followed with the application of a sigmoid activation function.

In accordance with one or more embodiments, the CNN (600) depicted in FIG. 6 is governed by a set of hyperparameters. The set of hyperparameters may include, but is not limited to: the size of the convolution kernel used in the convolutions of the CNN (600); the size of the max pooling kernels; the size of the upsampling kernels; the patch size used by the patch partitioner (804); and the number of encoding blocks (604), decoding blocks (614), and multiscale transformer and channel mixing blocks (630). The CNN hyperparameters may be selected by a user or may be identified during training using a set of data similar to the training data known as a validation set. In general, the CNN (600) of FIG. 6 can accept an input of almost any size so long as the convolutional operations and max pooling operations do not reduce the intermediate data below the defined kernel sizes of these operations, respectively.

To train a machine-learned model (e.g., the CNN (600)), training data must be provided. In accordance with one or more embodiments, training data may be collected from a variety of seismic surveys and/or synthetically generated. In one or more embodiments, synthetic seismic data sets are formed through perturbations of “real” seismic data (i.e., seismic data acquired through a seismic survey). In one or more embodiments, the perturbations are governed through a set of perturbation parameters, where the values of the perturbation parameters are determined based on the real data set. For example, in one or more embodiments, the values of the perturbation parameters are prescribed using statistical descriptions of the real data sets. In this manner, the synthetic data may be said to be informed by a prior, or prior information, derived from the real data sets.

Regardless of how the training data is acquired, an instance or single example of training data will include a seismic data set and accompanying target mask. The target mask is a data structure of the same size and shape as its associated seismic dataset, where each pixel, or grid point, can take on a binary value indicating the presence of a fault in the pixel or the lack of a fault.

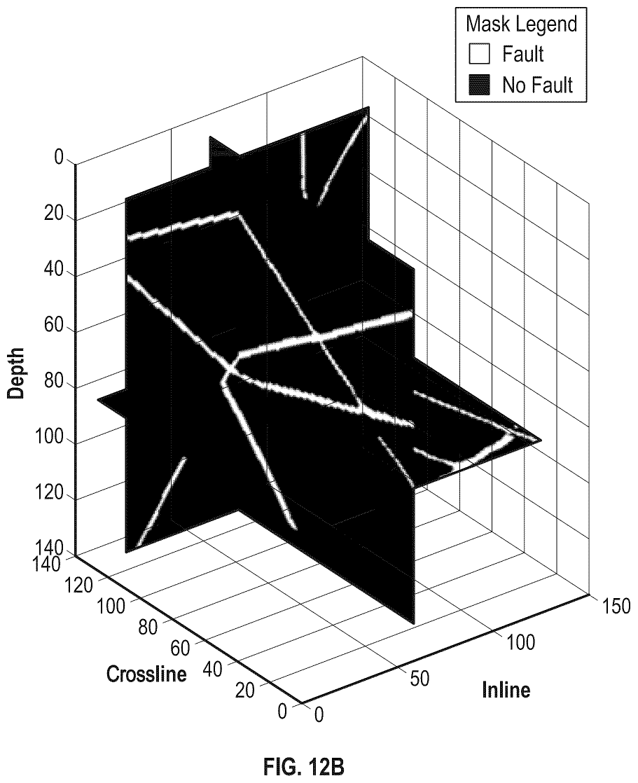

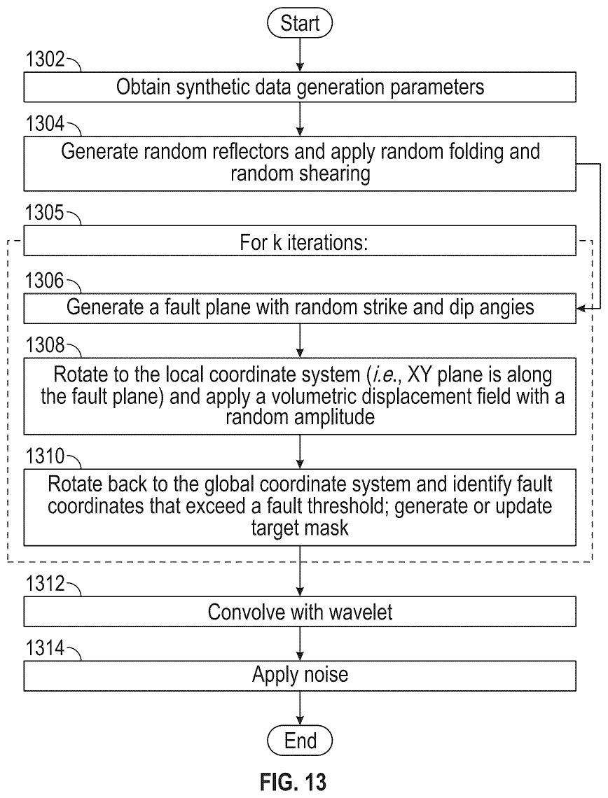

FIGS. 12A and 12B depict an example synthetically generated seismic data sets and accompanying target mask, respectively. In accordance with one or more embodiments, the training data for the machine-learned model is composed of many synthetic seismic data sets and accompanying target masks. Synthetic data, like the synthetic seismic data set and target mask shown in FIG. 12A and FIG. 12B, respectively, may be generated according to a synthetic data generation process.

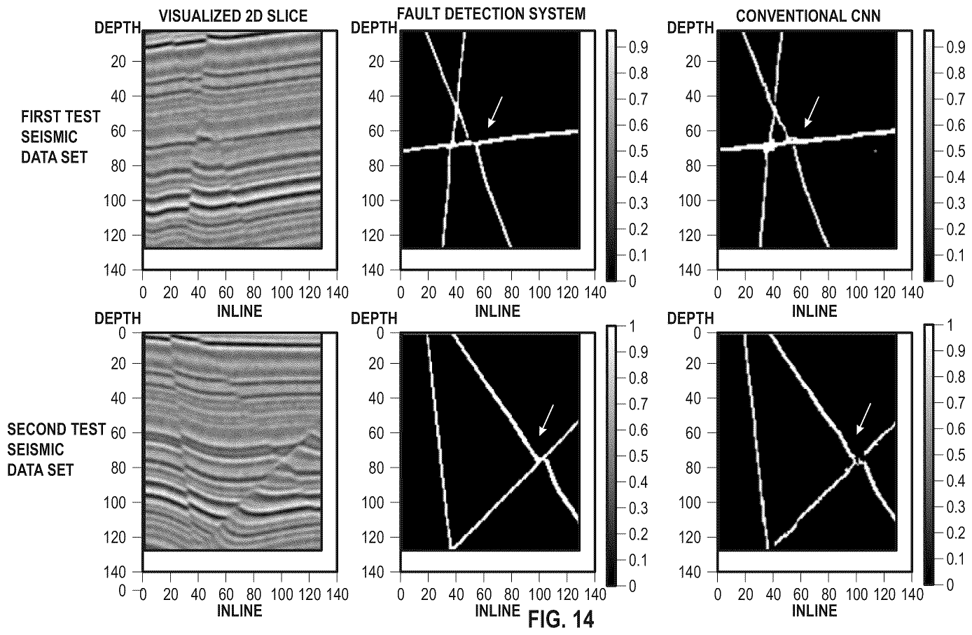

FIG. 13 depicts a flowchart outlining a synthetic data generation process, in accordance with one or more embodiments. It is noted that the process illustrated in FIG. 13, when implemented, generates a single seismic dataset and accompanying mask. To create a set of data used for training, validation, and testing of a machine-learned model, the synthetic data generation process of FIG. 13 may be implemented many times.

As seen in FIG. 13, in Block 1302, user-supplied synthetic data generation parameters are obtained. The synthetic data generation parameters control aspects of the synthetic data generation process. Herein, instances where a synthetic data generation parameter may control the behavior of a step or process in FIG. 13 are described while discussing the step or process. In general, a synthetic data generation parameter may be defined, by a user, as a fixed value or a ranges or sets, where, for a given synthetic seismic data set, a value is selected by random from within the range or set. For example, a user may prescribe a lower and upper bound for a synthetic data generation parameter. In some implementations, one or more synthetic data generation parameters may be described using a probability distribution, where a value is randomly selected according to the given distribution.

In Block 1304, a synthetic seismic data set is initiated by randomly generating J reflectors. The dimensionality and size of the synthetic seismic data set may be defined by one or more synthetic data generation parameters. In one or more embodiments, the dimensionality of a synthetically generated seismic dataset is set to 3 and each dimension has a size, or number of pixels or elements, set to 128. In these embodiments, the synthetic data generation parameters for dimensionality and size of the synthetically generated seismic data sets are set to fixed, immutable values. The synthetic data generation parameters may further include a distribution from which the value J, or the number of reflectors, is to be drawn. In one or more embodiments, the number of reflectors distribution is uniform with an upper and lower bound defined by a user in the synthetic data generation parameters. In one or more embodiments, the lower bound is set to 200 and the upper bound is set to 300 such that any synthetic seismic data set generated using these synthetic data generation parameters will contain between 200 and 300 reflectors. Upon generating the J reflectors, folding and shearing operations are applied. Again, parameters governing the folding and shearing operations may be supplied in the synthetic data generation parameters.

Block 1305, represents a loop where the encompassing blocks, Blocks 1306, 1308, and 1310, are sequentially applied for k iterations. The value for k, or a manner of selecting a value for k, is defined in the synthetic data generation parameters. In Block 1306, a fault plane is generated. The fault plane is defined by a strike angle and dip angle. The strike angle and dip angle or a method and/or distribution from which these values may be selected are provided in the synthetic data generation parameters.

In Block 1308, a rotation is performed to a local coordinate system where the XY plane of the local coordinate system is along the fault plane generated in the immediately preceding Block 1306. Once rotated, a volumetric displacement field with a random amplitude is applied. The volumetric displacement field is a matrix describing the displacement distribution in each volume grid. The displacement is at maximum on the fault plane and linearly decays with the vertical distance from the fault plane. The amplitude and rate of linear decay, or method of randomly selecting or randomly perturbing these quantities may be specified in the synthetic data generation parameters.

In Block 1310, a rotation back to the original, or global, coordinate system is performed. In one or more embodiments the global coordinates are x-North, y-East, and z-Depth. Once in the global coordinate system, the location of a fault is determined by comparing the seismic data set to a fault threshold. The fault threshold may be specified by a user and defined in the synthetic data generation parameters. In one or more embodiments, the fault threshold is 80% of the maximum displacement which is used to define the fault zone (several pixels, elements, or grid points) instead of the fault plane (one grid point). In these embodiments, all grid points with displacement greater than 80% of the maximum are selected as the fault zone. Further, a target mask is generated given the grid points that exceed the fault threshold. In one or more embodiments, when k>1 (i.e., when multiple fault planes are generated in a single synthetic seismic data set), a new target mask is not generated upon every iteration; rather the target mask is updated to reflect the newly added fault.

In Block 1312, the synthetic seismic data set is convolved with a wavelet. In one or more embodiments, wavelets available for selection and/or use may include, but are not limited to: Ormsby; Klauder; Butterworth; Ricker; and Gaussian. As such, in one or more embodiments, the synthetic data generation parameters define a set of available wavelets for use and a method of selecting a wavelet from the set. In one or more embodiments, a wavelet is selected from the set according to a probability distribution defined by the synthetic data generation parameters. In one or more embodiments, the wavelet is fixedly set to the Ricker wavelet.

Finally, in Block 1314, noise is added to the synthetic seismic data set in order to mimic behavior that occurs in seismic acquisition systems. Various types of noise may be added to the synthetic seismic data set. For example, random perturbations can be applied to each of the traces. The strength of the perturbations can be described by a variance. In one or more embodiments, the variance of noise applied to the synthetic seismic data set is randomly sampled from within a range bounded by a variance lower bound, σᵢ², and a variance upper bound, σᵤ². In one or more embodiments, the range of available variances is given in the synthetic data generation parameters. In one or more embodiments, static noise may also be applied to the synthetic seismic data set. Static noise is applied by shifting in time or depth, by a prescribed amount (e.g., random), the traces in the seismic data set. Further, in one or more embodiments, the amplitudes of various traces may be altered (e.g., multiplied by a random factor). Such an alteration injects noise into the synthetic seismic data set and is intended to mimic variation in seismic receiver (220) sensitivities or couplings. One with ordinary skill in the art will appreciate that noise can be added to the synthetic seismic data set in variety of ways and that not all noise injection schemes can be enumerated herein. Further, any noise injection scheme can be applied to the synthetic seismic dataset without departing from the scope of this disclosure.

It is noted that for concision, not all possible synthetic data generation parameters are described herein. However, one with ordinary skill in the art will recognize that many alterations to the synthetic seismic data generation process of FIG. 13 can be made without departing from the scope of this disclosure and that these alterations may necessitate fewer or additional synthetic data generation parameters.

To demonstrate the effectiveness of the fault detection system described herein, a CNN (600) with the architecture depicted in FIG. 6 was trained and tested using synthetically formed data sets and accompanying target masks. Each synthetic data set and target mask was generated according the processes depicted in FIG. 13. In total, 2100 3D synthetic data sets (which a size of 128×128×128) and target masks were generated. 2000 of the synthetic seismic data sets and associated target masks were reserved for training, 50 were reserved for validation, and 50 were reserved to testing the machine-learned model. To train the CNN (600), the dice loss function, given as

$$L ( y , \hat{y} ) = 1 - \frac{2 \sum y \hat{y} + 1}{\sum y + \sum \hat{y} + 1} , \qquad EQ 3$$

was used. In the dice loss function, y∈{0, 1} represents the ground truth label of each pixel for non-fault and fault, respectively. ŷ∈[0,1] represents the predicted fault probability. The summation is over all the pixels of the target mask. The dice loss measures the global overlap between the prediction and the target by a normalized cross-correlation, which naturally balances the data with biased positive/negative classes. In the fault detection task, the portion of the fault in a seismic image is very small. Therefore, this definition of dice loss is suitable for training the CNN (600) with such imbalanced data. For comparison, a second CNN was also trained using the synthetic seismic data sets and target masks. The architecture of the second CNN was a conventional U-net with basic skip connections (i.e., not multiscale transformer and channel mixing blocks) between pairs of encoding and decoding blocks. Hereafter, the second CNN will be referred to as a conventional CNN.

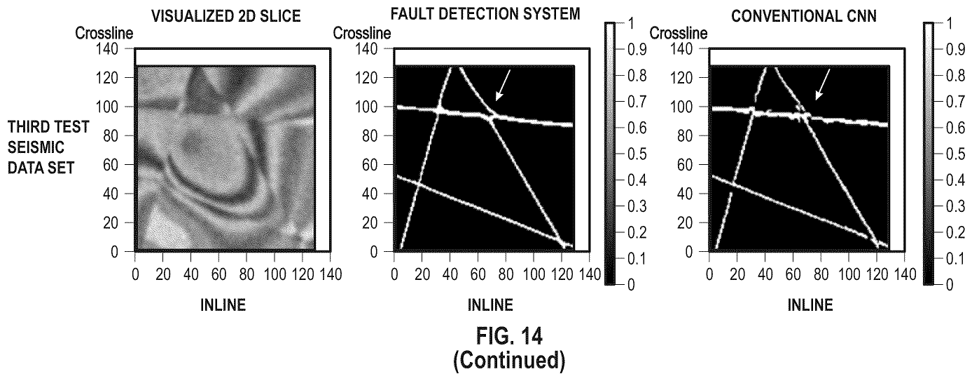

FIG. 14 depicts a detailed comparison of some results of the fault detection system of the present disclosure that uses a U-net style CNN with multiscale transformer and channel mixing blocks connecting encoding and decoding blocks with a conventional CNN. To ease visualization, while the processed seismic data sets were 3D volumes only 2D slices are shown. FIG. 14 is organized into rows and columns. Each row represents a different test seismic data set; namely, the first, second, and third test seismic data sets. The first column is a visual depiction of a 2D slice of the seismic data set. The second column indicates the results of the fault detection system, as described herein. The third column indicates the results of conventional CNN. Arrows show the fault intersections. In most cases, the fault detection system predicts clearer fault traces and better connectivity. Additionally, crossline cross-section and depth cross-section demonstrates that the fault detection system can predict precise shape of fault traces and the fault crossing relations are better resolved.

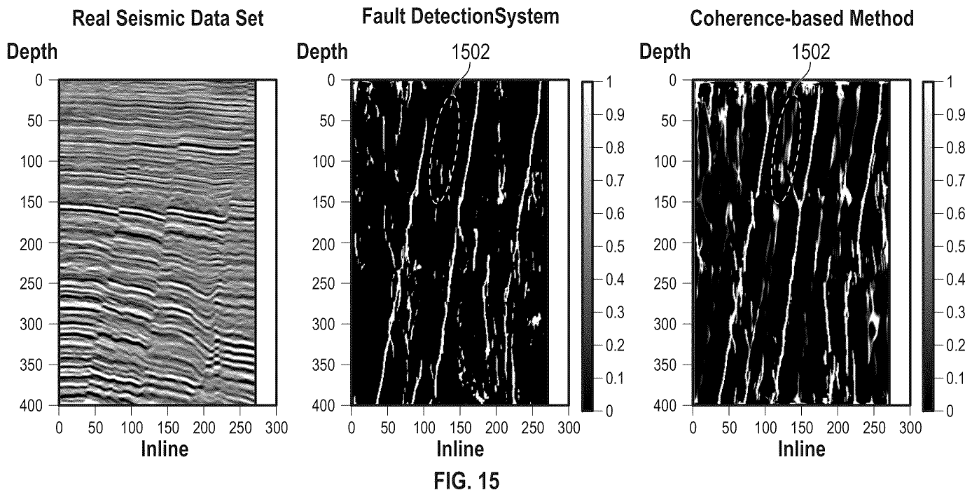

FIG. 15 depicts the results the fault detection system described herein applied to a real seismic data set (an inline section of a 3D cube). In particular, FIG. 15 depicts the fault probability predicted by fault detection system and, for comparison, the fault probability predicted by coherence-based method. The colormap indicates fault probability. In the results of FIG. 15, an ellipse encloses a region (1502) without fault in the seismic data set. This region (1502) is predicted “no fault” by the fault detection system of the present disclosure but demonstrates predicted “faults” by the coherence-based method.

FIGS. 14 and 15 both demonstrate improved performance of the fault detection system of the instant disclosure over a conventional CNN or conventional methods. Quantitatively, the precision and recall values for the fault detection system are 0.806 and 0.821, which outperforms the conventional CNN with precision and recall values of 0.759 and 0.772, respectively.

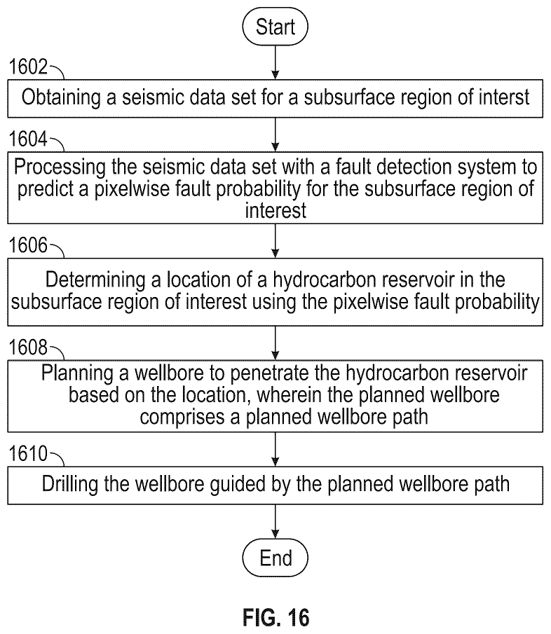

FIG. 16 depicts a flowchart outlining the use of the fault detection system, in accordance with one or more embodiments. In Block 1602, a seismic data set is obtained. The seismic data set may be obtained from a seismic survey. In one or more embodiments, the seismic data set may undergo one or more processing (or preprocessing) steps, such as the use of a bandpass filter, where the processing steps are intended to enhance the quality of the seismic data set (e.g., denoising). In Block 1604, the seismic data set is processed with the fault detection system described herein to predict a pixelwise fault probability for the subsurface region of interest. The pixelwise fault probability indicates that probability that each pixel (or grid point) of the input seismic data set is associated with a fault. In Block 1606, the location of a hydrocarbon reservoir is determined based on the pixelwise fault probability. In one or more embodiments, each pixel (or grid point) of the seismic data set is assigned as a “fault” or “no fault” through comparison of the pixel's fault probability with a given threshold. In one or more embodiments, the pixelwise fault probability (or the pixelwise fault assignation) is used by a reservoir simulator to determine the location a hydrocarbon reservoir. In Block 1608, a wellbore is planned to penetrate the hydrocarbon reservoir based on the determined location, where the wellbore plan includes a planned wellbore path. In Block 1610, a wellbore is drilled according to the planned wellbore path.

FIG. 17 shows a drilling system (1700) in accordance with one or more embodiments. Although the drilling system (1700) shown in FIG. 17 is used to drill a wellbore on land, the drilling system (1700) may also be a marine wellbore drilling system. The example of the drilling system (1700) shown in FIG. 17 is not meant to limit the present disclosure.

As shown in FIG. 17, a wellbore path (1702) may be drilled by a drill bit (1704) attached by a drillstring (1706) to a drill rig located on the surface (1707) of the earth. The drill rig may include framework, such as a derrick (1708) to hold drilling machinery. The top drive (1710) sits at the top of the derrick (1708) and provides torque, typically a clockwise torque, via the drive shaft (1712) to the drillstring (1706) in order to drill the wellbore. The wellbore may traverse a plurality of overburden (1714) layers and one or more cap-rock (1716) layers to a hydrocarbon reservoir (104) within the subterranean region of interest (102). In accordance with one or more embodiments, the extended bandwidth seismic dataset may be used to plan a wellbore including a wellbore path (1702) and drill a wellbore (1717) guided by the wellbore path (1702). The wellbore path (1702) may be a curved wellbore path, or a straight wellbore path. All or part of the wellbore path (1702) may be vertical, and some wellbore paths may be deviated or have horizontal sections.

Prior to the commencement of drilling, a wellbore plan may be generated. The wellbore plan may include a starting surface location of the wellbore, or a subsurface location within an existing wellbore, from which the wellbore may be drilled. Further, the wellbore plan may include a terminal location that may intersect with the target zone (1718), e.g., a targeted hydrocarbon-bearing formation, and a planned wellbore path (1702) from the starting location to the terminal location. In other words, the wellbore path (1702) may intersect a previously located hydrocarbon reservoir (104).

Typically, the wellbore plan is generated based on best available information at the time of planning from a geophysical model, geomechanical models encapsulating subterranean stress conditions, the trajectory of any existing wellbores (which it may be desirable to avoid), and the existence of other drilling hazards, such as shallow gas pockets, over-pressure zones, and active fault planes. In accordance with one or more embodiments, the wellbore plan is informed by an extended bandwidth seismic dataset produced using the machine-learned model (304) applied to a seismic dataset (302) acquired through a seismic survey (100) conducted over the subterranean region of interest (102).

The wellbore plan may include wellbore geometry information such as wellbore diameter and inclination angle. If casing (1724) is used, the wellbore plan may include casing type or casing depths. Furthermore, the wellbore plan may consider other engineering constraints such as the maximum wellbore curvature (“dog-log”) that the drillstring (1706) may tolerate and the maximum torque and drag values that the drilling system (1700) may tolerate.

A wellbore planning system (1750) may be used to generate the wellbore plan. The wellbore planning system (1750) may comprise one or more computer processors in communication with computer memory containing the geophysical and geomechanical models, the extended bandwidth seismic dataset, information relating to drilling hazards, and the constraints imposed by the limitations of the drillstring (1706) and the drilling system (1700). The wellbore planning system (1750) may further include dedicated software to determine the planned wellbore path (1702) and associated drilling parameters, such as the planned wellbore diameter, the location of planned changes of the wellbore diameter, the planned depths at which casing (1724) will be inserted to support the wellbore and to prevent formation fluids entering the wellbore, and the drilling mud weights (densities) and types that may be used during drilling the wellbore.

A wellbore (1717) may be drilled using a drill rig that may be situated on a land drill site, an offshore platform, such as a jack-up rig, a semi-submersible, or a drill ship. The drill rig may be equipped with a hoisting system, such as a derrick (1708), which can raise or lower the drillstring (1706) and other tools required to drill the well. The drillstring (1706) may include one or more drill pipes connected to form conduit and a bottom hole assembly (BHA) (1720) disposed at the distal end of the drillstring (1706). The BHA (1720) may include a drill bit (1704) to cut into subsurface (1722) rock. The BHA (1720) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit, the weight-on-bit, and the torque. The LWD measurements may include sensors, such as resistivity, gamma ray, and neutron density sensors, to characterize the rock formation surrounding the wellbore (1717). Both MWD and LWD measurements may be transmitted to the surface (1707) using any suitable telemetry system, such as mud-pulse or wired-drill pipe, known in the art.

To start drilling, or “spudding in” the well, the hoisting system lowers the drillstring (1706) suspended from the derrick (1708) towards the planned surface location of the wellbore (1717). An engine, such as a diesel engine, may be used to supply power to the top drive (1710) to rotate the drillstring (1706). The weight of the drillstring (1706) combined with the rotational motion enables the drill bit (1704) to bore the wellbore.

The near-surface is typically made up of loose or soft sediment or rock, so large diameter casing (1724), e.g., “base pipe” or “conductor casing.” is often put in place while drilling to stabilize and isolate the wellbore. At the top of the base pipe is the wellhead, which serves to provide pressure control through a series of spools, valves, or adapters. Once near-surface drilling has begun, water or drill fluid may be used to force the base pipe into place using a pumping system until the wellhead is situated just above the surface (1707) of the earth.

Drilling may continue without any casing (1724) once deeper, or more compact rock is reached. While drilling, a drilling mud system (1726) may pump drilling mud from a mud tank on the surface (1707) through the drill pipe. Drilling mud serves various purposes, including pressure equalization, removal of rock cuttings, and drill bit cooling and lubrication.

At planned depth intervals, drilling may be paused and the drillstring (1706) withdrawn from the wellbore. Sections of casing (1724) may be connected and inserted and cemented into the wellbore. Casing string may be cemented in place by pumping cement and mud, separated by a “cementing plug,” from the surface (1707) through the drill pipe. The cementing plug and drilling mud force the cement through the drill pipe and into the annular space between the casing and the wellbore wall. Once the cement cures, drilling may recommence. The drilling process is often performed in several stages. Therefore, the drilling and casing cycle may be repeated more than once, depending on the depth of the wellbore and the pressure on the wellbore walls from surrounding rock.

Due to the high pressures experienced by deep wellbores, a blowout preventer (BOP) may be installed at the wellhead to protect the rig and environment from unplanned oil or gas releases. As the wellbore becomes deeper, both successively smaller drill bits and casing string may be used. Drilling deviated or horizontal wellbores may require specialized drill bits or drill assemblies.

A drilling system (1700) may be disposed at and communicate with other systems in the well environment. The drilling system (1700) may control at least a portion of a drilling operation by providing controls to various components of the drilling operation. In one or more embodiments, the system may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a target zone (1718) is reached, or the presence of hydrocarbons is established.

In some embodiments the wellbore planning system (118, 1750), the seismic processing system (106), and the seismic interpretation workstation (110) may each include a computer system.

FIG. 18 further depicts a block diagram of a computer system (1802) used to provide computational functionalities associated with described algorithms, methods, functions, processes, flows, and procedures as described in this disclosure, according to one or more embodiments. The illustrated computer (1802) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1802) may include a computer that includes an input device, such as a keypad, keyboard, touch screen, or other device that can accept user information, and an output device that conveys information associated with the operation of the computer (1802), including digital data, visual, or audio information (or a combination of information), or a GUI.

The computer (1802) can serve in a role as a client, network component, a server, a database or other persistency, or any other component (or a combination of roles) of a computer system for performing the subject matter described in the instant disclosure. In some implementations, one or more components of the computer (1802) may be configured to operate within environments, including cloud-computing-based, local, global, or other environment (or a combination of environments).

At a high level, the computer (1802) is an electronic computing device operable to receive, transmit, process, store, or manage data and information associated with the described subject matter. According to some implementations, the computer (1802) may also include or be communicably coupled with an application server, e-mail server, web server, caching server, streaming data server, business intelligence (BI) server, or other server (or a combination of servers).

The computer (1802) can receive requests over network (1830) from a client application (for example, executing on another computer (1802) and responding to the received requests by processing the said requests in an appropriate software application. In addition, requests may also be sent to the computer (1802) from internal users (for example, from a command console or by other appropriate access method), external or third-parties, other automated applications, as well as any other appropriate entities, individuals, systems, or computers.

Each of the components of the computer (1802) can communicate using a system bus (1803). In some implementations, any or all of the components of the computer (1802), both hardware or software (or a combination of hardware and software), may interface with each other or the interface (1804) (or a combination of both) over the system bus (1803) using an application programming interface (API) (1812) or a service layer (1813) (or a combination of the API (1812) and service layer (1813). The API (1812) may include specifications for routines, data structures, and object classes. The API (1812) may be either computer-language independent or dependent and refer to a complete interface, a single function, or even a set of APIs. The service layer (1813) provides software services to the computer (1802) or other components (whether or not illustrated) that are communicably coupled to the computer (1802). The functionality of the computer (1802) may be accessible for all service consumers using this service layer. Software services, such as those provided by the service layer (1813), provide reusable, defined business functionalities through a defined interface. For example, the interface may be software written in JAVA, C++, or other suitable language providing data in extensible markup language (XML) format or another suitable format. While illustrated as an integrated component of the computer (1802), alternative implementations may illustrate the API (1812) or the service layer (1813) as stand-alone components in relation to other components of the computer (1802) or other components (whether or not illustrated) that are communicably coupled to the computer (1802). Moreover, any or all parts of the API (1812) or the service layer (1813) may be implemented as child or sub-modules of another software module, enterprise application, or hardware module without departing from the scope of this disclosure.

The computer (1802) includes an interface (1804). Although illustrated as a single interface (1804) in FIG. 18, two or more interfaces (1804) may be used according to particular needs, desires, or particular implementations of the computer (1802). The interface (1804) is used by the computer (1802) for communicating with other systems in a distributed environment that are connected to the network (1830). Generally, the interface (1804) includes logic encoded in software or hardware (or a combination of software and hardware) and operable to communicate with the network (1830). More specifically, the interface (1804) may include software supporting one or more communication protocols associated with communications such that the network (1830) or interface's hardware is operable to communicate physical signals within and outside of the illustrated computer (1802).

The computer (1802) includes at least one computer processor (1805). Although illustrated as a single computer processor (1805) in FIG. 18, two or more processors may be used according to particular needs, desires, or particular implementations of the computer (1802). Generally, the computer processor (1805) executes instructions and manipulates data to perform the operations of the computer (1802) and any algorithms, methods, functions, processes, flows, and procedures as described in the instant disclosure.

The computer (1802) also includes a memory (1806) that holds data for the computer (1802) or other components (or a combination of both) that can be connected to the network (1830). The memory may be a non-transitory computer readable medium. For example, memory (1806) can be a database storing data consistent with this disclosure. Although illustrated as a single memory (1806) in FIG. 18, two or more memories may be used according to particular needs, desires, or particular implementations of the computer (1802) and the described functionality. While memory (1806) is illustrated as an integral component of the computer (1802), in alternative implementations, memory (1806) can be external to the computer (1802).

The application (1807) is an algorithmic software engine providing functionality according to particular needs, desires, or particular implementations of the computer (1802), particularly with respect to functionality described in this disclosure. For example, application (1807) can serve as one or more components, modules, applications, etc. Further, although illustrated as a single application (1807), the application (1807) may be implemented as multiple applications (1807) on the computer (1802). In addition, although illustrated as integral to the computer (1802), in alternative implementations, the application (1807) can be external to the computer (1802).

There may be any number of computers (1802) associated with, or external to, a computer system containing computer (1802), wherein each computer (1802) communicates over network (1830). Further, the term “client,” “user,” and other appropriate terminology may be used interchangeably as appropriate without departing from the scope of this disclosure. Moreover, this disclosure contemplates that many users may use one computer (1802), or that one user may use multiple computers (1802).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a seismic data set for a subsurface region of interest;
processing the seismic data set with a fault detection system to predict a pixelwise fault probability for the subsurface region of interest; and
determining a location of a hydrocarbon reservoir in the subsurface region of interest using the pixelwise fault probability.

2. The method of claim 1, further comprising planning a wellbore to penetrate the hydrocarbon reservoir based on the location, wherein the planned wellbore comprises a planned wellbore path.

3. The method of claim 1, wherein the fault detection system comprises a U-net architecture convolutional neural network comprising an encoder branch with N ordered encoder blocks and a decoder branch with N ordered decoder blocks, wherein the N encoder blocks and N decoder blocks are paired and each pair is connected by a multiscale transformer and channel mixing block.

4. The method of claim 3, wherein each multiscale transformer and channel mixing block comprises:
a patch partitioner that partitions an array-structured input into patches;
a patch embedder that coverts a patch to a vector;
a transformer block; and
a channel mixing block.

5. The method of claim 4, wherein the transformer block comprises a Swin transformer.

6. The method of claim 2, further comprising drilling the wellbore guided by the planned wellbore path.

7. The method of claim 1, further comprising processing the seismic data set to improve the quality of the seismic data set.

8. A non-transitory computer readable medium storing instructions executable by a computer processor, the instructions comprising functionality for:
obtaining a seismic data set for a subsurface region of interest;
processing the seismic data set with a fault detection system to predict a pixelwise fault probability for the subsurface region of interest; and
determining a location of a hydrocarbon reservoir in the subsurface region of interest using the pixelwise fault probability.

9. The non-transitory computer readable medium of claim 8, wherein the instructions further comprise functionality for planning a wellbore to penetrate the hydrocarbon reservoir based on the location, wherein the planned wellbore comprises a planned wellbore path.

10. The non-transitory computer readable medium of claim 8, wherein the fault detection system comprises a U-net architecture convolutional neural network comprising an encoder branch with N ordered encoder blocks and a decoder branch with N ordered decoder blocks, wherein the N encoder blocks and N decoder blocks are paired and each pair is connected by a multiscale transformer and channel mixing block.

11. The non-transitory computer readable medium of claim 10, wherein each multiscale transformer and channel mixing block comprises:
a patch partitioner that partitions an array-structured input into patches;
a patch embedder that coverts a patch to a vector;
a transformer block; and
a channel mixing block.

12. The non-transitory computer readable medium of claim 11, wherein the transformer block comprises a Swin transformer.

13. The non-transitory computer readable medium of claim 9, wherein the instructions further comprise functionality for drilling the wellbore guided by the planned wellbore path.

14. The non-transitory computer readable medium of claim 8, wherein the instructions further comprise functionality for processing the seismic data set to improve the quality of the seismic data set.

15. A system, comprising:
a fault detection system configured to receive a seismic dataset and output a pixelwise fault probability; and
a computer configured to:
receive the seismic data set for a subsurface region of interest;
process the seismic data set with the fault detection system to predict the pixelwise fault probability for the subsurface region of interest; and
determine a location of a hydrocarbon reservoir in the subsurface region of interest using the pixelwise fault probability.

16. The system of claim 15, further comprising a wellbore planning system to plan a wellbore to penetrate the hydrocarbon reservoir based on the location, wherein the planned wellbore comprises a planned wellbore path.

17. The system of claim 16, further comprising a drilling system configured to drill a wellbore guided by the planned wellbore path.

18. The system of claim 15, wherein the fault detection system comprises a U-net architecture convolutional neural network comprising an encoder branch with N ordered encoder blocks and a decoder branch with N ordered decoder blocks, wherein the N encoder blocks and N decoder blocks are paired and each pair is connected by a multiscale transformer and channel mixing block.

19. The system of claim 18, wherein each multiscale transformer and channel mixing block comprises:
a patch partitioner that partitions an array-structured input into patches;
a patch embedder that coverts a patch to a vector;
a transformer block; and
a channel mixing block.

20. The system of claim 19, wherein the transformer block comprises a Swin transformer.
